(19) United States
(12) Patent Application Publication
(10) Pub. No.: US 2026/0177984 A1
(43) Pub. Date: Jun. 25, 2026

(54) STRIKING MECHANISM FOR WATCHES

(71) Applicant: Montres Breguet S.A., L'Abbaye (CH)

(72) Inventors: Younes KADMIRI, Montfaucon (FR); Grégory GAUTHIER, Saint-Cergue (CH); Jérôme MACE, Le Pont (CH); Jonas FAVRE, Veigy-Foncenex (FR)

(73) Assignee: Montres Breguet S.A., L'Abbaye (CH)

(21) Appl. No.: 19/393,778

(22) Filed: Nov. 19, 2025

(30) Foreign Application Priority Data
Dec. 20, 2024 (EP) 24222614.0

(51) Int. Cl. G04B 21/06; G04B 23/02

(52) U.S. Cl. CPC G04B 21/06; G04B 23/026

(57) ABSTRACT

A striking mechanism includes a resonant organ (12) and a hammer (11) including first (21) and second (22) parts that are assembled by a pivot connection to pivot relative to each other around an axis of rotation (30). The first and second parts respectively carry a first (26) and second (27) permanent magnets that form a magnetic return system between the two parts. The permanent magnets are arranged so as to generate an attractive force between them, pulling the first part and the second part towards a stable configuration of the hammer. During a strike, the first part comes to a stop against a fixed stop (24) before the second part, has reached the resonant organ, the percussion part then continuing its rotation towards the gong to complete the strike before moving back to the drive part to finally occupy a rest position, away from the gong.

### CROSS-REFERENCE TO RELATED APPLICATIONS

This application claims priority to European Patent Application No. 24222614.0, filed on December 20, 2024, the entire contents of which are incorporated herein by reference.

### TECHNICAL FIELD OF THE INVENTION

The present invention relates to a striking mechanism for a timepiece.

### TECHNOLOGICAL BACKGROUND

FIGS. 1 and 2 appended hereto are two partial views of a conventional striking mechanism. The views show a hammer 4, a resonant organ consisting of a gong 5, first return means consisting of a preload spring 6, a fixed stop 7 and second return means consisting of a resilient pin 8. The pin 8 is fastened to the hammer and its resilience is relatively low to limit bounce and, if possible, prevent such bounce. The operation of such a striking mechanism is known to the person skilled in the art, which is why only its essential features will be outlined below.

The hammer 4 is fitted so as to pivot around a fixed axis 9, and has a beak 10 for striking the gong. The preload spring 6 is arranged so as to press permanently against the resilient pin 8, so that the spring 6 permanently returns the hammer 4 towards the gong 5. FIGS. 1 and 2 show the striking mechanism in its stable configuration in which the hammer is in the rest position. It can be seen that in this position the hammer 4 bears against the fixed stop 7 by the resilient pin 8, and that the beak 10 and the gong 5 are separated by a small gap (FIG. 1). The width of the small gap between the gong and the hammer when the hammer is in the rest position is referred to as the “safety distance.” When the hammer 4 is in the rest position, the reaction force exerted by the fixed stop 7 counterbalances the force generated by the preload spring 6. The rest position is therefore a stable position.

When the mechanism is in the winding phase, the striking mechanism (known and not shown) lifts the hammer 4 against the force exerted by the preload spring 6. During this movement, the beak 10 gradually moves away from the gong 5, and the pin 8 simultaneously moves away from the fixed stop 7.

When the striking mechanism is released, it releases the hammer which then pivots abruptly towards the gong under the impulse of the preload spring 6. The flexible pin 8 is fastened to the hammer, and the mechanism is arranged such that this pin comes up against the fixed stop 7 before the beak 10 has reached the gong. However, as the pin 8 is resilient and the hammer 4 has considerable kinetic energy when the pin comes into contact with the fixed stop 7, the hammer is not stopped short by the fixed stop, but instead continues its movement, moving beyond its rest position and finally striking the gong 5, being heavily braked by the fixed stop on the path between its rest position and its gong percussion position. It will therefore be understood that it is due to the distortion of the resilient pin 8 that the hammer can strike the gong. After the impact on the gong, part of the energy is transmitted to the gong and returned to the hammer (partial elastic shock), enabling it to return to its stable position at a certain distance from the gong. The elastic energy released by the resilient pin 8, which resumes its unstressed form, is also added to the energy released by the gong. It is therefore understood that the resilient pin acts in particular as a second return means, as the force it exerts opposes that of the preload spring 6 so as to keep the beak 10 of the hammer away from the resonant organ 5 when the hammer is in its rest position. Thus, the preload spring 6, the fixed stop 7 and the flexible pin 8 together define the stable/rest position of the hammer.

The mechanism from the prior art described above has certain drawbacks. In particular, part of the kinetic energy from the hammer is used to distort the resilient pin, so that the hammer is slowed down before striking the gong. It will be understood that functioning in this way limits the energy efficiency of the striking work. One possible solution to this problem would be to move the fixed stop closer to the gong. This modification would reduce the distance the hammer would have to travel beyond the fixed stop, thereby limiting the distortion imposed on the resilient stop. However, by thus reducing the kinetic energy drawn by the resilient pin when the hammer pivots from its rest position to the gong, it also increases the likelihood that the hammer will bounce with each strike. Such bouncing is undesirable. Indeed, it is known that this tends to keep the gong from vibrating freely. So the designer of a striking mechanism has to find a compromise between energy efficiency, on one hand, and sufficient safety distance between the hammer in the rest position and the gong, on the other. This requires a design with few tolerances, a complex assembly and an adjustment of the safety position that is difficult and time-consuming even for an experienced horologist.

Patent EP 2048548 provides one solution to the above problem. This prior art document describes a striking mechanism that includes many of the characteristics of the more conventional striking mechanism described above. The main distinguishing characteristic of the striking mechanism described in this document EP 2048548 compared with the mechanism described above is that the hammer is not made in one piece, but instead comprises a first part and a second part that are hinged together by a hinge, the first part being fitted so as to be rotationally mobile on the second part. The first part of the hammer comprises the striking beak (or striking zone) which is for striking the gong, while the second part is arranged so as to pivot around a fixed axis of the striking mechanism and is exposed to the driving force of the preload spring. The first part therefore forms a percussion part, while the second part forms a drive part and defines the rest position of the hammer. The first and second parts of the hammer are connected by a connecting spring and arranged so as to be rotationally mobile between a stable configuration, in which the first part rests against a stop zone on the second part, and a striking configuration, in which the first part is moved away from the stop zone and the striking beak moves towards the gong as the tension on the connecting spring increases. More specifically, the hammer comprises a circular blade spring, one end of which is fastened to the first part and the other end of which bears against a part on the second part. The blade spring is pre-tensioned so as to permanently return the first and second parts of the hammer to the first stable configuration, in which the hammer is at rest.

When the striking mechanism is at rest or in the winding phase, the hammer is in its stable configuration. When at a given moment the striking work is released, the mechanism abruptly releases the hammer, namely said second part on which the hammer loading and release mechanism acts, allowing the hammer as a whole to pivot rapidly towards the gong without changing its configuration. The mechanism is arranged so that, as it pivots, the second part of the hammer comes up against a fixed stop fitted on a support on the mechanism, before the striking beak on the first part can reach the gong. The second part of the hammer is stopped short by the fixed stop. However, the articulation and the connecting spring between the first and second parts of the hammer allow the first part to continue its movement on its own, thereby moving into the striking configuration, before finally striking the gong.

The pivoting of the first part of the hammer around the hinge against the return force exerted by the blade spring causes the hammer to momentarily change its configuration. Then, after the impact on the gong, the latter releases some of the energy it has received, allowing the first part of the hammer to return to its stable configuration. The elastic energy associated with the return force exerted by the blade spring is added to the energy released by the gong. It will therefore be understood that, according to EP 2048548 B1, it is the blade spring that acts as a second return means.

The striking mechanism described in document EP 2048548 B1 is advantageous but also has certain drawbacks. Indeed, even if it can be acknowledged with the authors of this document that the use of a hammer in two articulated parts connected by a spring makes it easier to set the position of the fixed stop relative to the gong and in particular allows the striking beak to be moved further away from the gong in the rest position while ensuring that the gong is struck by this beak, the characteristics of the striking mechanism described do not make it possible a priori to eliminate the bounce phenomenon that adversely affects the quality of the sound emitted by the watch, as will also be explained later.

### SUMMARY OF THE INVENTION

One of the main purposes of the present invention is to remedy the drawbacks of the prior art that have just been described, and in particular to reduce the risk of the hammer bouncing after the gong has been struck, without significantly reducing the energy efficiency of the striking device. The present invention achieves this and other purposes by providing a striking mechanism according to the appended claim 1.

The striking mechanism is arranged such that, when the hammer is in the stable configuration and the drive part comes up against the fixed stop during a rotation in the first direction, the kinetic energy of the percussion part drives the latter against the second return means towards the resonant organ over an angular path of the percussion part relative to the drive part, the hammer then momentarily leaving the stable configuration. In accordance with the invention, the second return means comprise two magnetic elements fixedly carried by the drive part and the percussion part, respectively, these two magnetic elements being arranged so as to generate between them a magnetic force returning, at least over an initial part of the angular path, the percussion part and the drive part to the said stable configuration of the hammer

In the graph in the appended FIG. 6, curve 1 and curve 2 respectively relate to first and second embodiments of the invention, which will be described in detail below. Curve 3 relates to the striking mechanism described in document EP 2048548 already discussed. This curve 3 is given as a comparison to understand at least one significant advantage of the invention. Each curve shows the evolution of the return couple exerted by the second return means according to the angle α between the percussion part and the drive part, from a situation in which the drive part of the hammer is held stationary against the fixed stop while the percussion part approaches the gong to touch the gong at a strike position α F.

The three striking mechanisms corresponding to the three couple curves in FIG. 6 have been configured such that the energy stored by the resilient system (connecting spring) from the prior art and in each of the two magnetic systems according to the invention is substantially identical at the strike position α F, to enable a valid comparison. As shown by couple curve 3, for the striking mechanism from the prior art, the intensity of the couple exerted by the second return means, namely by the connecting spring, increases substantially linearly as the percussion part of the hammer moves away from the stable configuration (physical property of springs). On the other hand, as shown by couple curves 1 and 2, with striking mechanisms conforming to the present invention, the intensity of the return couple is, in an initial angular range from the rest position, much greater than that of the mechanism from the prior art. In the first embodiment of the invention, the return force in the stable position can be substantially identical to that of the pre-tensioned connecting spring. Then, in the first embodiment, the return couple reaches a maximum before the halfway point (particular case) and then decreases and becomes relatively weak near the strike position. The return couple in the magnetic system in the second embodiment is at its maximum in the stable rest position and then decreases rapidly as it approaches the strike position. The graph in FIG. 6 also shows the angular positions 1a, 2a and 3a corresponding to 20% of said stored energy and the angular positions 1b, 2b and 3b corresponding to 60% of said stored energy at the strike position, respectively, for the three coupling systems corresponding to curves 1, 2 and 3. It can be seen that the energy stored in the coupling system increases very rapidly in the second embodiment and less rapidly in the first embodiment. However, in the latter case, the increase in stored energy remains much more rapid than in the resilient system from the prior art.

The striking mechanism and in particular the magnetic coupling system between the drive part and the percussion part can be arranged such that the residual energy from the percussion part, after it has come up against the rear stop of the drive part during the first bounce, is approximately equal to 60% of said energy stored in the magnetic coupling system in the strike position. It is understood from the foregoing that striking mechanisms according to the invention provide a better guarantee that there will be no complete bounce after a strike, meaning that the striking beak does not touch the gong again after a strike, in particular that the striking beak does not touch the gong that is vibrating as a result of the strike.

### BRIEF DESCRIPTION OF THE FIGURES

Other features and advantages of the present invention will become apparent from the following detailed description, given solely by way of non-limiting example and in reference to the attached drawings in which:

FIGS. 1 and 2, which have already been described, are two partial views, in plan and in perspective, respectively, of a conventional striking mechanism from the prior art;

FIG. 3 is a plan view of a first embodiment of the striking mechanism according to the invention;

FIGS. 4A and 4B are perspective front and rear views of the striking mechanism in FIG. 3;

FIG. 5 is a perspective view of a second embodiment of the striking mechanism according to the invention;

FIG. 5A is an enlarged close-up view showing more specifically the two magnetic elements and the rear hammer stop means in the striking mechanism in FIG. 5; and

FIG. 6 is a diagram of curves showing the return couple according to the displacement angle of the percussion part relative to the drive part for an embodiment from the prior art and the two embodiments of the invention described in detail.

### DETAILED DESCRIPTION OF THE INVENTION

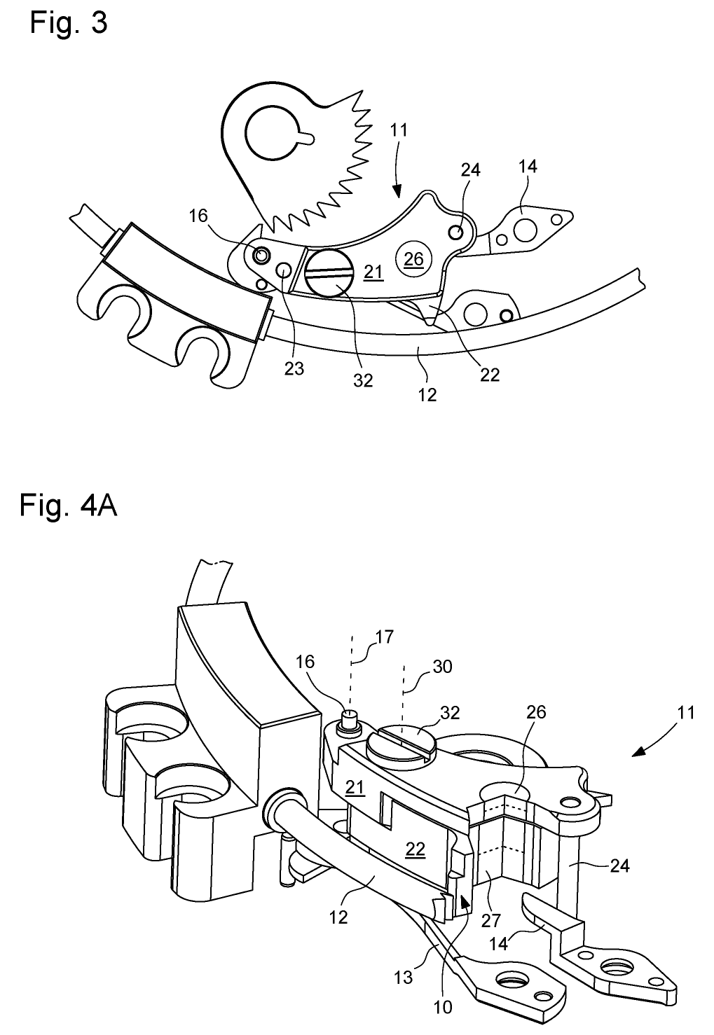

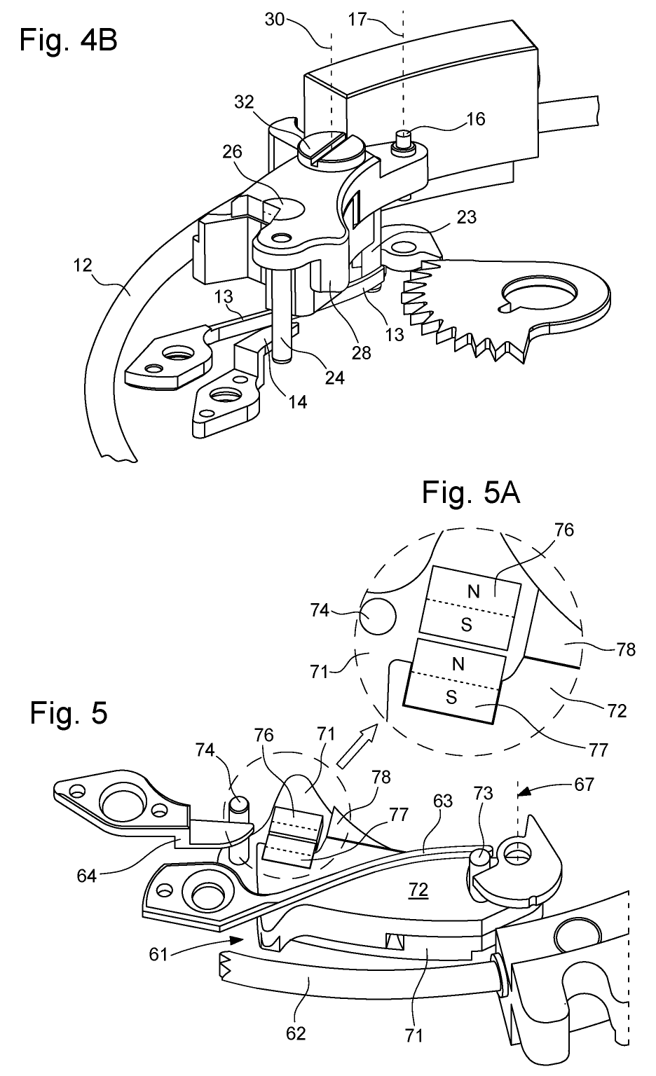

FIGS. 3 and 4A, 4B appended hereto show a first embodiment of the striking mechanism according to the invention. The illustrated striking mechanism comprises a hammer 11, a resonant organ consisting of a gong 12, first return means consisting of a preload spring 13, and a fixed stop 14. It will be understood that the elements that have just been listed are carried by a support that is not shown. The hammer 11 comprises a first part 21, referred to as the drive part, and a second part 22, referred to as the percussion part. The drive part 21 and the percussion part 22 of the hammer are assembled by a pivot connection so that they can rotate relative to each other around a geometric axis 30 defined by the drive part 21, the hinge between parts 21 and 22 being made, for example, of a tube running through the percussion part 22 and ending in a small flange that supports the lower end of this percussion part, this tube being held in place by a screw 32 with its head resting on the drive part and screwed into the tube. It should be noted that the hole for the screw 32 in the drive part can be threaded and the screw 32 thus screwed into this drive part.

Parts 21 and 22 are for the most part superimposed and the drive part 21 is arranged so as to pivot around a geometric axis 17 defined by an arbor 16 (material axis) fitted onto part of the support on the striking mechanism, with its two pivots in respective holes in this part. The drive part 21 is arranged so as to be rotationally mobile on the support, while the percussion part 22 is arranged so as to be rotationally mobile on the drive part. Alternatively, parts 21 and 22 are both fitted so as to be rotationally mobile around the same geometric axis that is fixed relative to the support, the two parts being rotationally mobile relative to each other at least over a certain angular distance allowing the percussion part to strike the gong 12 while the drive part 21 is stopped by the stop 14 in its rotational movement, in a first direction, towards the gong.

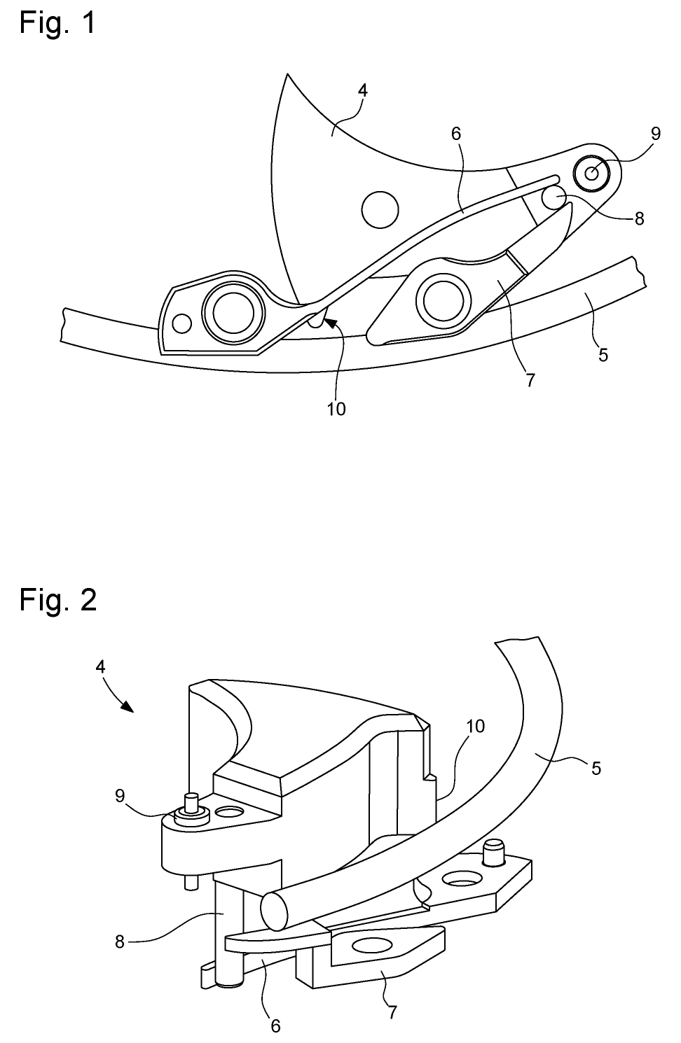

The preload spring 13 is fastened to the support by one of its ends, and its other end is arranged so as to permanently bias the drive part 21 clockwise (first direction) around the axis 17 (the expressions “clockwise” and “counterclockwise” appearing in the description of the present embodiment are to be understood with reference to FIG. 3). As also shown in FIGS. 3, 4A and 4B, the drive part 21 carries two rigid pins 23 and 24. The pin 23 is provided to act as a support surface by means of which the preload spring 13 biases the drive part 21 in the first direction around the axis of rotation 17, while the pin 24 is positioned so that it comes up against the fixed stop 14 to stop the pivoting of the drive part 21 when the latter has reached a determined angular position, in a rotational movement in the first direction from a loaded position, corresponding to the rest position. It will be understood that, unlike the flexible pin 5 on the striking mechanism in FIGS. 1 and 2, the pin 24 in the present embodiment is preferably rigid. As a result, it can also have a certain flexibility, as the drive part does not have to be stopped short without travelling over a small angular deceleration path. One advantage of the striking mechanism according to the invention is that the fixed stop 14 can be arranged so that, when the hammer is in the rest position, the striking beak 10 is relatively far from the gong. Indeed, since the percussion part 22 rotates towards the gong 12 relative to the drive part 21, it is no longer necessary to precisely adjust the position of the striking beak 10 relative to the gong when the hammer is in the rest position, at a relatively short distance from the gong, as in conventional striking devices.

As has already been mentioned, the drive part 21 and the percussion part 22 are both arranged so as to pivot, the former around geometric axis 17 and the latter around geometric axis 30, so that the hammer 11 can change configuration by pivoting parts 21 and 22 relative to each other. The striking mechanism also comprises second return means that are arranged to exert two opposing return couples on the drive part and the percussion part, respectively, so as to return the drive part 21 and the percussion part 22 to a first mutual configuration, referred to as the stable configuration of the hammer 11. More specifically, the purpose of the second return means is to return the percussion part towards the drive part, the latter being stopped in its travel towards the gong while the percussion part continues its travel towards gong 12 to strike. Thanks to these second return means, the hammer has a stable rest position in which the striking beak is away from the gong. In addition, the purpose of these second return means is to prevent multiple bounces and, if possible, to prevent any complete bounce; this is better achieved by the present invention with the chosen second return means, which are formed by two magnetic elements 26, 27 carried respectively by the drive part 21 and by the percussion part 22 of the hammer 11. In accordance with the invention, the second return means consist of two magnetic elements that are fixedly carried by the drive part 21 and the percussion part 22. The two magnetic elements 26 and 27 are arranged so as to generate between them an attractive force returning the drive part 21 and the percussion part 22 to the stable configuration of the hammer 11. In the illustrated example, the magnetic elements 26 and 27 consist of two cylinder-shaped permanent magnets. The magnetic axis of these magnets coincides with the axis of the cylinder. According to the first embodiment, the permanent magnets 26 and 27 are both oriented with their magnetic axis parallel to the axis of rotation 30. It can be said that the two permanent magnets are axially oriented. To achieve an attractive magnetic force, both magnets have the same polarity. In a particular variant, both magnets are positioned with their respective centres at equal distance from the axis of rotation 30 around which the percussion part 22 can pivot relative to the drive part 21.

The drive part 21 comprises a rear stop 28 with several functions. A first function is to define the stable configuration of the hammer 11, the percussion part advantageously bearing against this rear stop in this stable configuration; this even being necessary in the embodiments and variants in which it is provided that the second return means exert a certain couple (pre-tensioning) on the percussion part 22 in the stable configuration, in which the hammer is at rest, in its rest position. A second function of the rear stop 28 is to synchronously drive the percussion part 22 when the drive part 21 is released after the hammer 11 has been loaded by the striking mechanism. A third function of the rear stop is to act as a damper for the percussion part 22 when the latter undergoes a return movement towards the drive part 21 after the gong 12 has been struck. This third function is important, because it enables the residual mechanical energy from the percussion part that bounces after a strike to be absorbed, preventing a complete bounce and thereby keeping the striking beak 10 from touching the gong again, which is a primary purpose of the present invention. The rear stop is preferably rigid and solid to provide effective damping of the percussion part 22 when the latter moves backwards after the gong has been struck. Moreover, this rear stop advantageously has a relatively large contact surface with the percussion part. Lastly, the rear stop 28 is advantageously arranged so that the centre of mass of the percussion part 22 is on a circle, centred on the axis of rotation 30, which runs through said contact surface on this rear stop.

The operating principle of the striking mechanism according to the invention is substantially the same as the one described in patent document EP 2048548 which has already been discussed. This document is incorporated by reference in this patent application. When the striking mechanism is at rest or in the winding phase, the hammer 11 is in its stable configuration. When, at a given moment, the striking mechanism is released, the mechanism immediately releases the drive part 21 of the hammer, allowing the hammer as a whole to pivot abruptly around the geometric axis 17 towards the gong 12 without changing its configuration. The mechanism is arranged so that, as it pivots, the drive part comes up against the fixed stop 14 before the percussion part 22 can reach the gong 12, preferably at a relatively large angular distance compared with the aforementioned safety distance. The drive part 21 is stopped by the fixed stop 14 via the pin 24. However, the articulation between the drive part 21 and the percussion part 22 allows the percussion part to continue its movement on its own, eventually striking the gong 12.

The pivoting of the percussion part 22 around the hinge against the return couple exerted by the permanent magnets 26, 27 causes a transient change in the configuration of the hammer 11. Then, after the percussion part has struck the gong 12, the gong returns some of the energy it has received to the percussion part. Magnetic energy associated with the return force exerted by permanent magnets 26 and 27 is added to the energy returned by the gong, meaning magnetic energy stored in the magnetic system formed by these two permanent magnets.

Also referring to FIGS. 3, 4A and 4B, it can be seen that the drive part 21 and the percussion part 22 are largely superimposed, with both magnets 26, 27 lying respectively above and below a dividing plane that is perpendicular to the axis of rotation 30. It will also be understood that, when the two parts of the hammer 11 pivot relative to each other, at least one of the two magnets moves parallel to this dividing plane. The figures show the striking mechanism with the hammer in its stable configuration, the magnetic axes of the two magnets 26, 27 then being either substantially aligned or advantageously slightly offset so as to have, in the first embodiment, an initial magnetic force couple in the stable configuration of the hammer and thus in the rest position of the hammer. The magnetic axes of the magnets 26, 27 are oriented in the same direction, meaning that they have the same polarity, and the magnetic force that each magnet exerts on the other is an attractive force. One advantage associated with the first embodiment, particularly in the variant shown, is that the magnetic force is oriented parallel to the axis of rotation 30. Under these conditions, the magnetic force has the effect of pressing an upper surface of the percussion part 22 against a lower surface of the drive part 21. It will be understood that such a design is advantageous for stopping the pivoting of the percussion part relative to the drive part, first when the hammer is in its stable configuration, and then to contribute to the damping of the percussion part during a partial bounce after the gong has been struck. Therefore, the initial magnetic force couple mentioned earlier is not essential for the percussion part to be stable in the stable configuration of the hammer, particularly when the hammer is in the rest position.

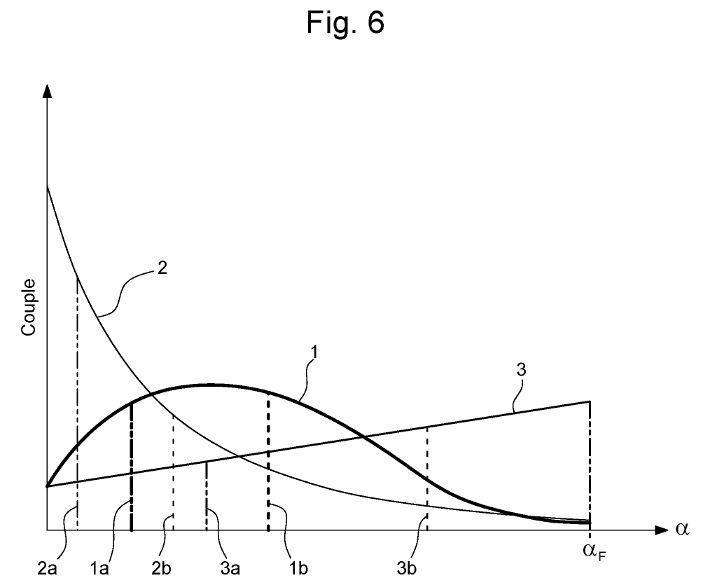

Returning now to the graph in FIG. 6, which has already been discussed, it is understood that curve 1 shows the change in the return couple exerted by the second return means, namely the two permanent magnets 26 and 27 that are axially oriented according to the angle α between the percussion part 22 and the drive part 21, in a situation in which the drive part of the hammer 11 has remained stationary against the fixed stop 14 after having come up against it, while the percussion part 22 continues its rotational movement in the first direction (forward movement) by turning around the axis of rotation 17. It should be noted that it is possible, even likely, for the drive part to undergo a small bounce movement after striking the fixed stop 14, while the percussion part continues its rotational movement towards the gong. As already explained, in the particular variant described, the return couple generated by the magnets 26, 27 has a non-zero value, due to a small angular lag expected between the two respective magnetic axes of the two magnets, when the hammer is in its stable configuration and therefore in particular when it is at rest. The return couple increases rapidly as the angle α between the two parts 21, 22 of the hammer deviates from the stable configuration and it remains at a relatively high value over a relatively long angular distance of the angular path travelled by the percussion part 22 on its own, the permanent magnets 26, 27 remaining partially superimposed. Lastly, the return couple decreases rather quickly, as soon as the two magnets are separated for the most part in projection in a plane orthogonal to the axis of rotation 30, on a final section of the angular path of the percussion part between the rest position and the strike position. In this variant of curve 1 in FIG. 6, the magnets are configured such that the intensity of the return couple reaches a maximum value when the two parts 21 and 22 of the hammer are rotated relative to each other, and then decreases relatively quickly before the striking beak 10 touches the gong 12. With the magnetic system according to the invention, moving the striking beak away from the gong in the rest position of the hammer only slightly affects the energy efficiency of the striking device, since the magnetic force between the two magnetic elements decreases and becomes weak or even negligible, at least in a final section of the angular path of the percussion part between the rest position and the strike position.

The drive part 21 of the hammer 11 on the striking mechanism shown in FIGS. 3 and 4A, 4B carries a single permanent magnet 26. Alternatively, the drive part can comprise, for example, an upper portion carrying a first magnet and a lower portion carrying a second magnet with the same polarity, the first and second magnets being fitted in the drive part with their magnetic axes in line with each other, or in other words, aligned. In this alternative form of the first embodiment (which is not illustrated ), the percussion part is arranged to freely interlock with the drive part between the lower and upper portions of the drive part, such that the magnet it carries is, in the stable configuration, inserted between the upper and lower portions of the drive part. As the percussion part pivots relative to the drive part around the axis of rotation (defined by the hinge between the two parts), the magnet in the percussion part moves between the upper portion and the lower portion in a plane perpendicular to the axis of rotation. When the hammer is in its stable configuration, the magnetic axes of the magnet in the percussion part and of the two magnets in the drive part are substantially aligned. In a first variant all three of their magnetic axes are polarised in the same direction. In this first variant, the attractive force exerted by the first magnet in the drive part on the magnet in the percussion part counterbalances the attractive force exerted by the second magnet in this percussion part. This means that at least most of the frictional force between the drive part and the percussion part is lost, which can also be an advantage in terms of limiting the energy lost by the percussion part before striking the gong 12 from the rest position of this percussion part. In a second variant, the polarity of the permanent magnet carried by the percussion part is reversed relative to the two permanent magnets carried by the drive part. In this case, the stable configuration of the hammer is provided with the magnet in the percussion part upstream of the magnets in the drive part with the percussion part bearing against a rear stop defining the stable configuration. The magnetic system will be configured such that the kinetic energy from the percussion part is sufficient to easily overcome a magnetic potential peak generated by the magnetic repulsion forces at play when the magnets are aligned in both directions of rotation, the magnetic system returning the percussion part to the stable position over an initial part of the angular path of this percussion part, relative to the drive part, between the rest position and the strike position. It should be noted that the permanent magnet carried by the percussion part or the permanent magnets carried by the drive part can be respectively replaced, in another variant, by a chip made of a diamagnetic material and by two chips made of such diamagnetic material.

It will be further understood that, according to another variant of the present embodiment, the second return means could comprise only one permanent magnet oriented parallel to the axis of rotation 30. In this case, the other magnetic element could, for example, be a chip made of a soft ferromagnetic material with high magnetic permeability. In this case, the behaviour of the return couple exerted by the second return means according to the angle between the percussion part 22 and the drive part 21 would be qualitatively similar to curve 1 in FIG. 6.

FIGS. 5 and 5A appended hereto show a second embodiment of the striking mechanism according to the invention. The striking mechanism shown has a large number of characteristics in common with that of the first embodiment, which is why not all of the characteristics of the second embodiment will be described again in detail. It should also be noted that, in FIG. 5, elements similar to the ones already described in connection with FIGS. 3, 4A and 4B have the same reference number increased by fifty.

Referring now to FIGS. 5 and 5A, it can be seen that the striking mechanism illustrated comprises a hammer 61, a resonant organ consisting of a gong 62, first return means consisting of a preload spring 63, and a fixed stop 64. The hammer 61 comprises a first drive part 71 and a second percussion part 72. The parts 71 and 72 are assembled by a pivot connection such that they can be rotated relative to each other around an axis of rotation 67. It can be seen that, in the present example, parts 71 and 72 are for the most part superimposed and they are both arranged so that they can turn, separately from each other over at least a certain angular distance, around the axis of rotation 67, which remains fixed relative to the support. This is a first main difference relative to the variant shown in the first embodiment, this first difference relating to an alternative in the assembly of the two parts 71 and 72. Thus on one hand, the axis of rotation 67 acts as a fixed axis of rotation to enable the drive part 71, together with the percussion part 72, to pivot relative to the fixed support when the hammer is winding and when a strike is released, and on the other hand it acts as an axis of rotation around which the percussion part can pivot relative to the drive part in order to strike the gong, as previously explained. Although the material axis in question is not expressly shown in FIG. 5, its position is indicated by the geometric axis 67.

As also shown in FIG. 5, the drive part 71 carries two pins referenced 73 and 74 that are parallel to the axis of rotation 67 and fastened on the side of the drive part 71 facing the percussion part 72. The pins 73 and 74 are relatively long, such that they extend beyond the percussion part 72. It can also be seen that the percussion part 72 has an oblong opening (not referenced) through which the pin 73 runs, the oblong opening enabling the relative rotational movement foreseen between the parts 71 and 72. It will be understood that the oblong opening is sufficiently large so that the pin 73 is free to move tangentially as the percussion part 72 pivots relative to the drive part 71. As also shown in FIG. 5, the preload spring 63 bears against the pin 73 at one end, while its other end is fastened to the support. The preload spring 63 thus acts as first return means arranged to permanently bias the drive part 71 in a counterclockwise direction (first direction/forward direction) around the axis of rotation 67 (the expressions “clockwise” and “counterclockwise” appearing in the description of the present embodiment are to be understood with reference to FIG. 5). As for the pin 74, it is positioned so as to come up against the fixed stop 64 to stop the pivoting of the drive part 71 relative to the support when the latter has reached a predetermined angular position corresponding to the rest position of part 71.

As has already been mentioned, the hammer 61 can change configuration by pivoting parts 71 and 72 relative to each other. The striking mechanism also comprises second return means that are arranged to exert a return couple on the percussion part 72 relative to the drive part 71 so as to return the drive part and the percussion part to a first mutual configuration, referred to as the stable configuration of the hammer 61.

In accordance with the invention, the second return means consist of two magnetic elements that are carried respectively by the drive part 71 and the percussion part 72 of the hammer 61. The two magnetic elements 76 and 77 are arranged so as to generate between them an attractive force returning the drive part 71 and the percussion part 72 to the stable configuration of the hammer 61. In the illustrated example, the magnetic elements consist of two rectangular permanent magnets 76, 77. The respective magnetic axes of these permanent magnets are substantially aligned in the stable configuration of the hammer 61 and therefore in the rest position of this hammer. In the second embodiment, the magnetic axes of the two magnets 76, 77 lie in the same plane that is perpendicular to the axis of rotation 67. This implies in particular that the centres of the two magnets 76, 77 are contained in said plane, and it is further understood that the magnets move relative to each other in the same plane when the hammer 61 changes configuration. This is the second main difference between the first and second embodiments, this second difference being a major one since it relates to the magnetic system according to the invention of the striking device described. Each of the two permanent magnets is rigidly fastened to the part of the hammer 61 that carries it, and the two magnets 76, 77 are positioned with their respective centres at equal distance from the axis of rotation 67 around which the drive part 71 and the percussion part 72 can pivot relative to the support and relative to each other (particular case). Under these conditions, it will be understood that, when the hammer 61 is in its stable configuration, as illustrated in FIGS. 5 and 5A, the magnetic axes of the two permanent magnets are substantially aligned. Both permanent magnets are also polarised in the same direction, so that the force each magnet exerts on the other is an attractive magnetic force.

In the variant shown, the drive part 71 also comprises a rear stop 78 that plays the same role as in the first embodiment. In addition, this rear stop 78 also makes it possible to keep the two magnets 71, 72 in the magnetic system, forming the second return means, from coming up against each other during the return/backward movement of the percussion part after a strike.

Returning now to the graph in FIG. 6, which has already been discussed, it is understood that curve 2 is the counterpart of curve 1, but relates to a striking mechanism according to the second embodiment. It can be seen that the return couple generated by the magnets 76, 77 reaches its maximum value when the hammer is in its stable configuration / rest position and this maximum value is relatively high. Unlike curve 1, curve 2 decreases rapidly and asymptotically from the stable configuration to zero as the percussion part separates from the drive part.

As already mentioned, the drive part 71 and the percussion part 72 comprise a rear stop 78 arranged to engage so as to keep the percussion part 72 from pivoting relative to the drive part 71 beyond the stable configuration of the hammer 61 in the clockwise/first direction. In the second embodiment, the fact that the return couple is significant in the stable configuration makes the rear stop 28 essential. A simpler solution would be to use the two permanent magnets as stops. However, the use of the rear stop 78 illustrated in FIGS. 5 and 5A makes it possible to guarantee a minimum spacing between magnets 76 and 77, so as to keep the initial attraction force (and therefore the energy consumption) from being too high and also to protect the permanent magnets from the shock of the percussion part against the drive part during the return/backward movement of the percussion part after the gong 62 has been struck.

It will be understood that, according to a variant of the second embodiment, the second return means can comprise only one magnet oriented in a plane perpendicular to the axis of rotation 67. In this case, the other magnetic element could be made of a soft ferromagnetic material with high magnetic permeability. The behaviour of the return couple exerted by the second return means according to the angle α between the percussion part 72 and the drive part 21 would be qualitatively similar to curve 2 in FIG. 6.

It will also be understood that various modifications and/or improvements that are apparent to a person skilled in the art can be made to the embodiments described herein without departing from the scope of the present invention as defined by the appended claims.

### Terminology

4. hammer

5 gong

6. preload spring

7. fixed stop

8. flexible pin

9. fixed axis

10. beak

11. hammer

12. resonant organ / gong

13. preload spring

14. fixed stop

17. fixed axis of rotation

21. drive part

22. percussion part

23., 24. pin

26., 27. permanent magnet

28. rear stop

61. hammer

62. resonant organ / gong

63. preload spring

64. fixed stop

67. fixed axis of rotation

71. drive part

72. percussion part

73., 74. pin

76., 77. permanent magnet

78. rear stop

1. A striking mechanism for a timepiece comprising a support, a resonant organ, a hammer, a stop that is fixed relative to the support, first return means and second return means,
the hammer comprising a first part, referred to as the drive part, and a second part, referred to as the percussion part, arranged so as to be able to strike the resonant organ, the drive part being fitted so as to pivot on the support around a first axis of rotation between a first position, referred to as the rest position, against the fixed stop, and a second position, referred to as the wound position, away from the fixed stop, the first return means being arranged such that they permanently return the drive part in a first direction to the fixed stop and can rotate this drive part in the first direction from the wound position after the release of a strike on the resonant organ,
the drive part and the percussion part being assembled by a pivot connection such that the percussion part can pivot relative to the drive part around a second axis of rotation, and the second return means being arranged to exert a return couple between the drive part and the percussion part so as to return the drive part and the percussion part to a first configuration, referred to as the stable configuration of the hammer,
the striking mechanism being arranged such that the percussion part is separated from the resonant organ when the hammer is in the stable configuration and the drive part is in the rest position against the fixed stop, the striking mechanism being arranged such that, when the hammer is in the stable configuration and the drive part comes up against the fixed stop while rotating in the first direction, the kinetic energy of the percussion part drives the latter against the second return means towards the resonant organ over an angular path of the percussion part relative to the drive part, the hammer then momentarily leaving the stable configuration;
wherein the second return means comprise two magnetic elements respectively fixedly carried by the drive part and the percussion part, these two magnetic elements being arranged so as to generate between them a magnetic force returning, at least over an initial part of said angular path, the percussion part and the drive part to the stable configuration of the hammer.

2. The striking mechanism according to claim 1, wherein at least one of the two magnetic elements is a permanent magnet.

3. The striking mechanism according to claim 2, wherein the magnetic axis of said at least one magnet is parallel to the second axis of rotation.

4. The striking mechanism according to claim 2, wherein the magnetic axis of said at least one magnet lies in a plane perpendicular to the second axis of rotation.

5. The striking mechanism according to claim 1, wherein the two magnetic elements are respectively two permanent magnets arranged in magnetic attraction.

6. The striking mechanism according to claim 5, wherein each of the two permanent magnets is rigidly fastened to the part of the hammer that carries it; and wherein the respective magnetic axes of the two permanent magnets are substantially coincident when the hammer is in said stable configuration.

7. The striking mechanism according to claim 5, wherein the centres of the two permanent magnets are constantly located at the same distance from the second axis of rotation.

8. The striking mechanism according to claim 1, wherein the second axis of rotation is parallel to the first axis of rotation and spaced apart from said first axis of rotation.

9. The striking mechanism according to claim 1, wherein the first axis of rotation and the second axis of rotation are coincident.

10. The striking mechanism according to claim 1, wherein the drive part comprises a rear stop that limits rotation of the percussion part relative to the drive part in the direction opposite to said first direction.

11. The striking mechanism according to claim 10, wherein the rear stop forms a damper for the percussion part when the latter undergoes a return movement towards the drive part after the resonant organ has been struck.

12. The striking mechanism according to claim 11, wherein the rear stop forms a means of driving the percussion part by the drive part when the drive part is rotated from said loaded position by the first return means after the release of a strike on the resonant organ.

13. The striking mechanism according to claim 10, wherein the percussion part bears against the rear stop when the hammer is in the stable configuration.
